(19) United States
(12) Patent Application Publication
(10) Pub. No.: US 2025/0084695 A1
(43) Pub. Date: Mar. 13, 2025

(54) BUFFERING DEVICE CAPABLE OF LOWER-LIMIT POSITION ADJUSTMENT

(71) Applicant: CSL SUNMASTER ENTERPRISES CO., LTD., KAOHSIUNG CITY (TW)

(72) Inventor: HSIU-CHIH TAO, KAOHSIUNG CITY (TW)

(21) Appl. No.: 18/462,668

(22) Filed: Sep. 7, 2023

(51) Int. Cl. E06B 9/42

(52) U.S. Cl. CPC E06B 9/42; E06B 2009/402

(57) ABSTRACT

A buffering device capable of lower-limit position adjustment includes a fixed sleeve, a constricting spring, an adjustment ring, a sleeve base, and a lower-limit position defining base. An external force can be applied to the adjustment ring to push one of the two end portions of the constricting spring toward the other such that the constricting spring is elastically loosened and no longer tightly wound around the outer periphery of the fixed sleeve. The pushed end portion then sequentially pushes the sleeve base and the lower-limit position defining base in a rotating manner such that an inner tube of a roller blind is moved in an axial direction with respect to the lower-limit position defining base. By adjusting the distance between the lower-limit position defining base and an upper-limit position defining base along a threaded section of the inner tube, the lower-limit position of the roller blind can be adjusted.

### BACKGROUND OF THE INVENTION

### 1. Technical Field

The present invention relates to a buffering device for a roller blind, wherein the buffering device defines the lower-limit position of the roller blind and allows the lower-limit position to be adjusted without having to dismantle the roller blind.

### 2. Description of Related Art

Nowadays, a roller blind is typically provided with a buffering device for defining the upper-limit position and lower-limit position of the roller blind, thereby preventing the roller blind from moving past the upper or lower edge of the corresponding window when the roller blind is raised or lowered. For example, a common buffering device for defining the upper-limit position and lower-limit position of a roller blind is disclosed in Taiwan Utility Model Patent No. M605068, which was published on Dec. 11, 2020, and is titled “ROLLER BLIND WITH SETTABLE UPPER-LIMIT AND LOWER-LIMIT POSITIONS AND BUFFERING DEVICE THEREOF.” This patent discloses a buffering device that includes an inner tube, a first slidable base, a first position-limiting base, and a second position-limiting base. When a roller blind fabric is driven to extend downward by a driving assembly, the driving assembly also drives the first slidable base into abutment against the first position-limiting base in order for the abutment to stop the driving assembly from lowering the roller blind fabric. When the roller blind fabric is driven to move upward by the driving assembly, the driving assembly drives the first slidable base into abutment against the second position-limiting base instead, and the abutment will stop the driving assembly from raising the roller blind fabric. With the first position-limiting base producing a position-limiting effect on the roller blind fabric when the roller blind fabric is lowered, and the second position-limiting base producing a similar effect when the roller blind fabric is raised, there is no need to worry that the roller blind fabric will be damaged by being excessively lowered or excessively raised.

The buffering device in the '068 patent for setting an upper-limit position and a lower-limit position is so structured that the upper-limit and lower-limit positions cannot be adjusted unless an outer tube, to which the roller blind fabric is connected, is removed. Therefore, if the lower-limit position of a roller blind is found to be incorrect after the roller blind is mounted on the wall above a window, the entire roller blind must be detached from the wall in order to make the adjustment; in other words, adjusting the lower-limit position during installation of the roller blind can be troublesome and time-consuming. This leaves much to be desired in terms of use.

### BRIEF SUMMARY OF THE INVENTION

In view of the aforesaid drawback of the lower-limit position adjustment structure of the conventional roller blind buffering devices, the present invention provides a buffering device capable of lower-limit position adjustment. The buffering device is mounted to a roller blind and includes a fixed sleeve, at least one constricting spring, an adjustment ring, a sleeve base, and a lower-limit position defining base. The fixed sleeve is mounted around, but cannot rotate with respect to, a bar of the roller blind, wherein the bar extends in an axial direction. The constricting spring is tightly wound around the outer periphery of the fixed sleeve in the axial direction. The constricting spring has two end portions, and when an external force is applied to push the two end portions toward each other, the constricting spring is elastically loosened and therefore no longer tightly wound around the outer periphery of the fixed sleeve. The adjustment ring is mounted around the outer periphery of the constricting spring and is provided with an opening. Each of the two lateral edges of the opening forms a pushing portion, and the two end portions of the constricting spring are located between the two pushing portions. When the adjustment ring is rotated, one of the pushing portions is subjected to the external force and transfers the external force to, and thereby pushes, the corresponding end portion of the constricting spring. The sleeve base is mounted around the outer periphery of the adjustment ring. The sleeve base is protrudingly provided with a push block, and the push block extends into the opening of the adjustment ring and is located between the two end portions of the constricting spring such that when any one of the end portions is pushed by the corresponding pushing portion, the end portion pushes the push block and thereby rotates the sleeve base. The lower-limit position defining base is threadedly provided on an inner tube of the roller blind. The lower-limit position defining base can be rotated by the sleeve base via a transmission spring in order to move the inner tube in the axial direction with respect to the lower-limit position defining base.

The bar has a non-circular cross section. One end of the fixed sleeve is provided with a first axial hole in the axial direction, the first axial hole has the same cross-sectional shape as the bar, and the wall of the first axial hole is located around the bar in a movable manner.

The adjustment ring is provided with a second axial hole in the axial direction, and the wall of the second axial hole is located around the outer periphery of the constricting spring along the axial direction.

The adjustment ring is provided with a turning portion at one end.

An elastic element is provided between the sleeve base and the turning portion.

The sleeve base is provided with a third axial hole in the axial direction, and the wall of the third axial hole is located around the outer periphery of the adjustment ring along the axial direction.

The wall of the third axial hole is protrudingly provided with the push block in the axial direction.

A protective cover is mounted around the outer periphery of the sleeve base.

The lower-limit position defining base is threadedly provided on a threaded section of the inner tube. The lower-limit position defining base includes a first base body and a second base body that are coupled to each other. The transmission spring has a first end coupled to the sleeve base and a second end coupled to the first base body. The sleeve base rotates the first base body through the transmission spring.

The first base body is provided with a fourth axial hole in the axial direction, the wall of the fourth axial hole is located around the outer periphery of the bar along the axial direction, and the wall of the fourth axial hole is protrudingly provided at one end with a coupling portion in the axial direction. The second base body is provided with a fifth axial hole in the axial direction, and one end of the fifth axial hole is provided with a coupling groove in the axial direction. The coupling portion is engaged in the coupling groove such that the first base body can rotate the second base body. The other end of the fifth axial hole is provided with an internally threaded portion in the axial direction, and the internally threaded portion is threadedly connected to the threaded section of the inner tube such that when the second base body is rotated, the threaded section is moved in the axial direction with respect to the internally threaded portion.

The foregoing technical features have the following advantages:
1. The buffering device allows the lower-limit position of the roller blind to be adjusted right away, without having to detach the entire set of roller blind from the wall or remove any component of the roller blind.
2. Since the lower-limit position of the roller blind can be adjusted in a simple and easy way during the installation process, the time and effort required for assembling the roller blind can be greatly reduced. The buffering device is particularly suitable for use where a large number of roller blinds have to be installed and adjusted.
3. The rotational inertia generated by lowering the roller blind can drive the push block to push the corresponding end portion of the constricting spring away from the other end portion in a rotating manner, such that the constricting spring is even more tightly wound around the outer periphery of the fixed sleeve to counteract the rotational inertia, thereby producing a braking effect to prevent the roller blind from being lowered excessively.

### BRIEF DESCRIPTION OF THE SEVERAL VIEWS OF THE DRAWINGS

FIG. 1 is an exploded perspective view of an embodiment of the present invention.

FIG. 2 shows the buffering device according to the embodiment in FIG. 1 mounted to a roller blind.

FIG. 3 is a perspective view of the buffering device in FIG. 2.

FIG. 4 is a sectional view of the buffering device in FIG. 2.

FIG. 5 is a partial enlarged sectional view of the buffering device in FIG. 4.

FIG. 6 is a sectional view taken along line VI-VI in FIG. 4.

FIG. 7 is similar to FIG. 4 except that the slidable base has been moved toward the upper-limit position defining base.

FIG. 8 is similar to FIG. 4 except that the slidable base has been moved toward the lower-limit position defining base.

FIG. 9 is similar to FIG. 6 except that one of the pushing portions has pushed the corresponding end portion of the constricting spring in a rotating manner, and that this end portion has, in turn, pushed the push block into rotational movement.

FIG. 10 is similar to FIG. 8, showing an adjustment of the distance between the lower-limit position defining base and the upper-limit position defining base along the threaded section of an inner tube.

FIG. 11 is similar to FIG. 9 except that the push block has pushed one of the two end portions of the constricting spring away from the other end portion and thereby wound the constricting spring even more tightly in an elastic manner.

### DETAILED DESCRIPTION OF THE INVENTION

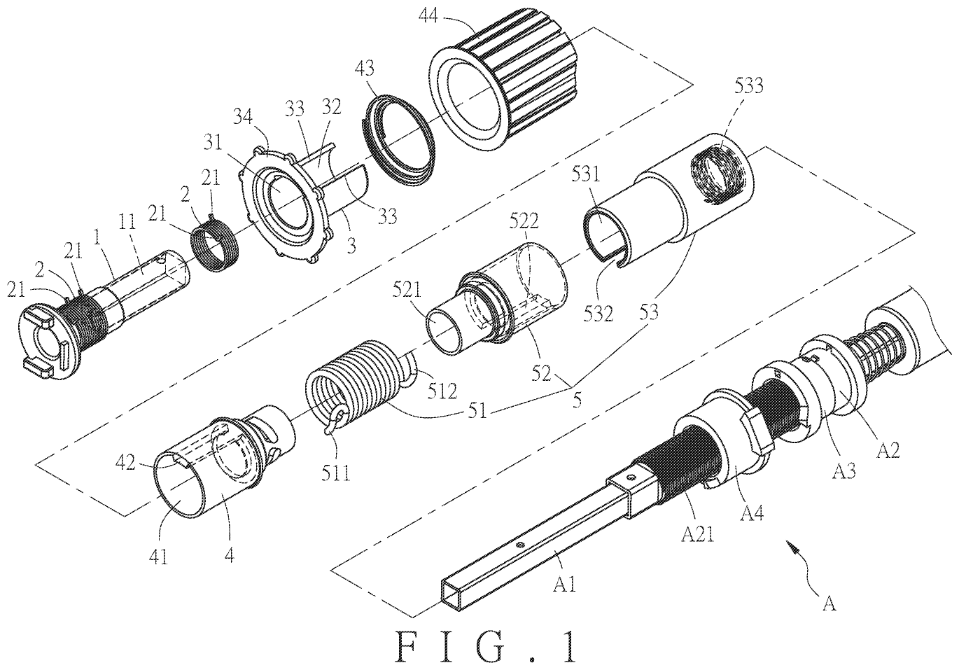

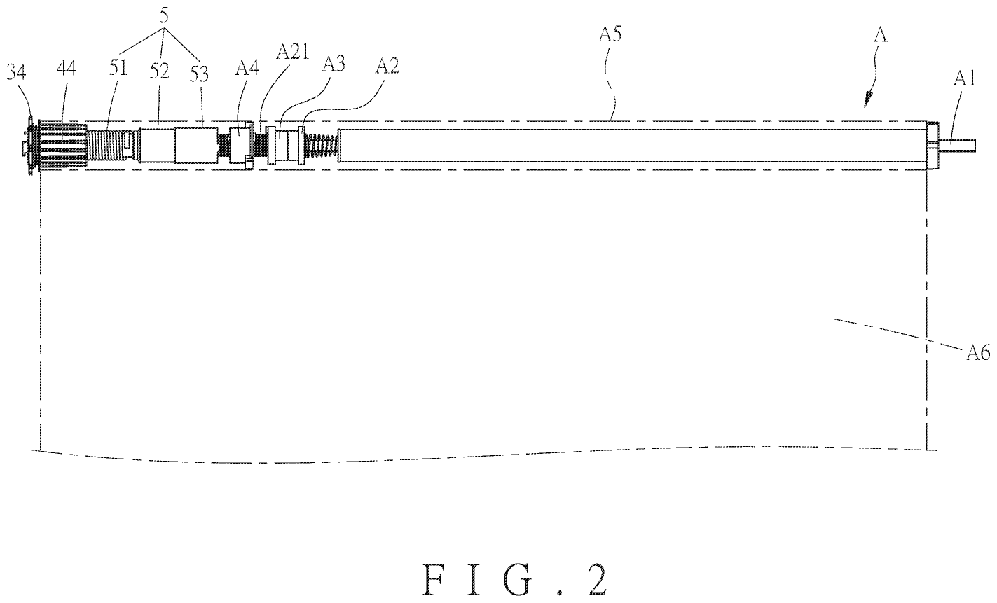

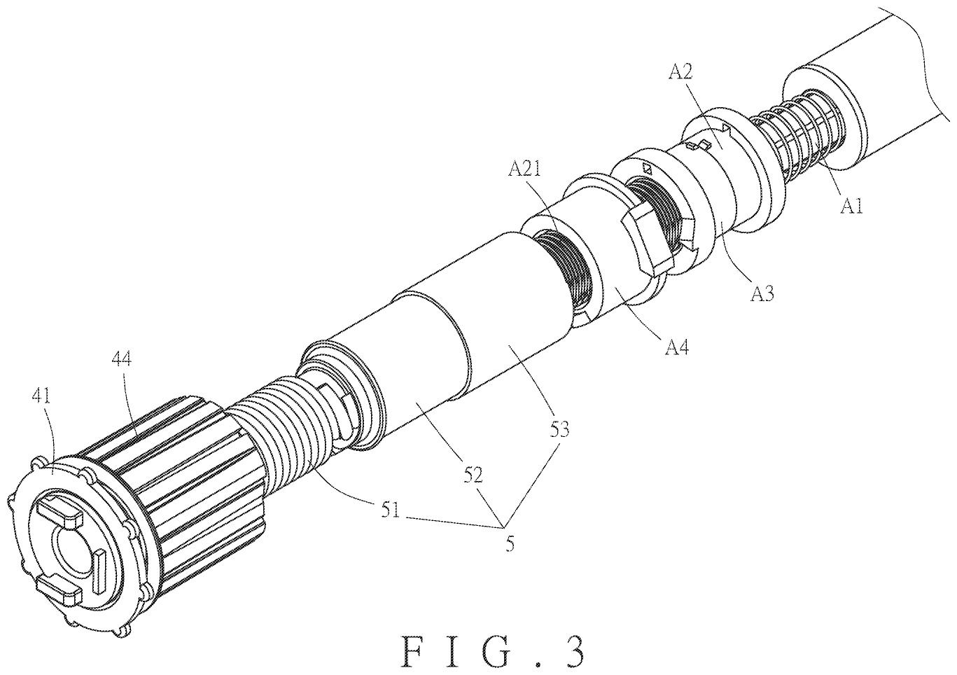

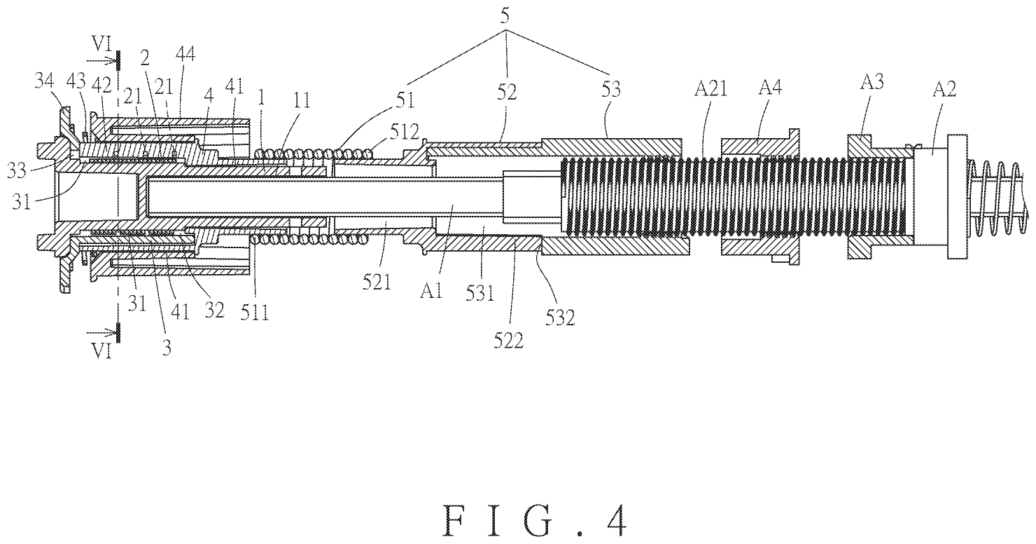

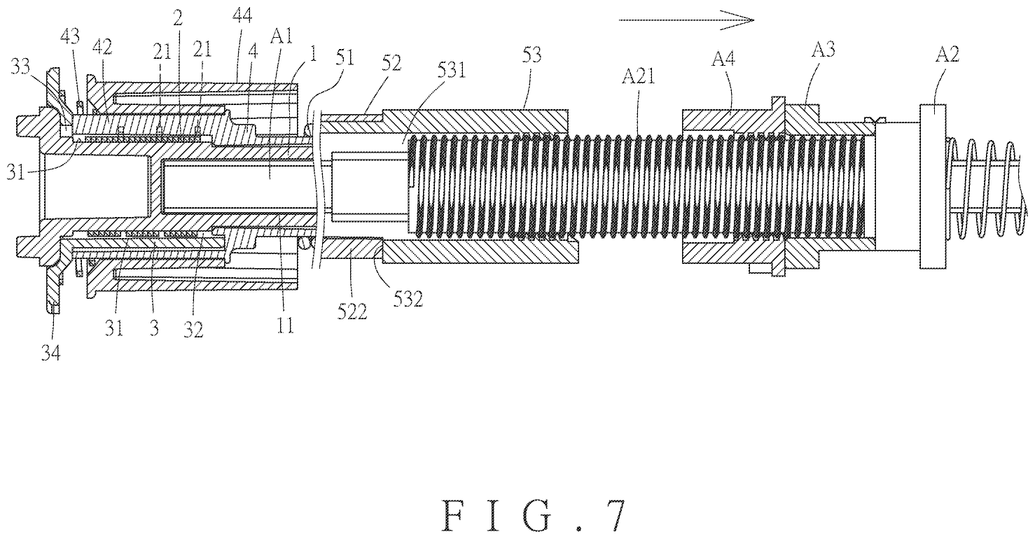

Referring to FIG. 1, FIG. 2, and FIG. 3, one embodiment of the present invention provides a buffering device that allows a lower-limit position to be adjusted and that is mounted to a roller blind A. The roller blind A is provided with a bar A1 having a non-circular cross section. The bar A1 extends in an axial direction. An inner tube A2 is mounted around the bar A1, can be moved along the bar A1 in the axial direction, but cannot rotate with respect to the bar A1. The outer periphery of the inner tube A2 is provided with a threaded section A21. An upper-limit position defining base A3 and a slidable base B4 are threadedly provided on the threaded section A21 (see FIG. 4). An outer tube A5 is mounted around the outer periphery of the upper-limit position defining base A3 and the outer periphery of the slidable base A4, and the outer tube A5 is configured to connect with a roller blind fabric A6. When the outer tube A5 reels in, and thereby raises, the roller blind fabric A6, the outer tube A5 also drives the slidable base A4 to approach the upper-limit position defining base A3 in a rotating manner. Once the slidable base A4 contacts the upper-limit position defining base A3, the outer tube A5 is stopped from raising the roller blind fabric A6 (see FIG. 7), and an upper-limit position is thus formed.

With continued reference to FIG. 1, FIG. 2, and FIG. 3, this embodiment of the present invention includes a fixed sleeve 1, at least one constricting spring 2, an adjustment ring 3, a sleeve base 4, and a lower-limit position defining base 5.

The fixed sleeve 1 is provided at one end with a first axial hole 11 in the axial direction. The first axial hole 11 has the same cross-sectional shape as the bar A1, and the diameter of the first axial hole 11 is equal to the outer diameter of the bar A1 so that the fixed sleeve 1 can be mounted around the bar A1 in a movable manner. More specifically, the fixed sleeve 1 can only be moved in the axial direction along, but cannot be rotated with respect to, the bar A1.

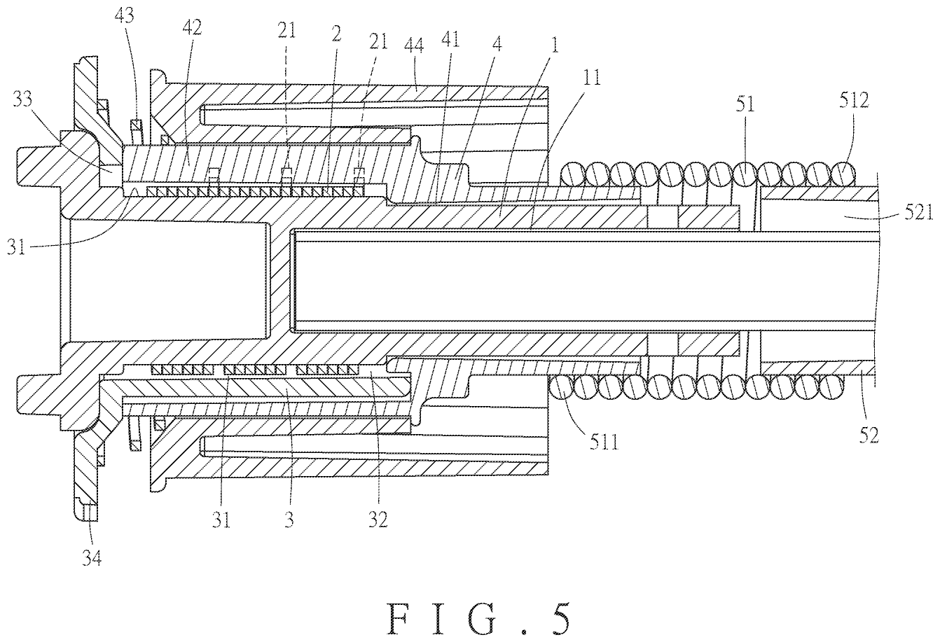

The at least one constricting spring 2 is tightly wound around the outer periphery of the fixed sleeve 1 in the axial direction (see FIG. 5). In this embodiment of the present invention, three constricting springs 2 are sequentially arranged along, and tightly wound around the outer periphery of, the fixed sleeve 1. The two ends of each constricting spring 2 are each provided with an end portion 21. When an external force is applied to push the two end portions 21 of any constricting spring 2 toward each other, the constricting spring 2 will be elastically loosened and therefore cease to be tightly wound around the outer periphery of the fixed sleeve 1, and when the external force is removed, the constricting spring 2 will once again be tightly wound around the outer periphery of the fixed sleeve 1 thanks to the elastic restoring force the constricting spring 2.

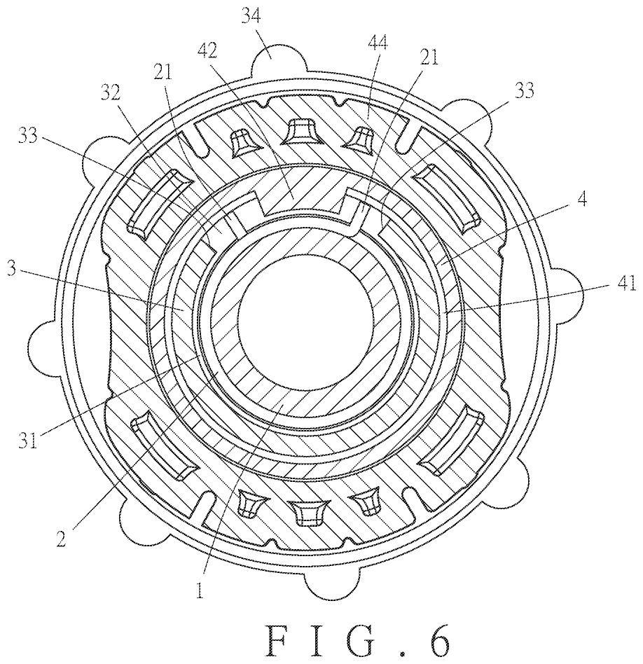

The adjustment ring 3 is provided with a second axial hole 31 in the axial direction so that the adjustment ring 3 can be mounted around the outer peripheries of the constricting springs 2 in the axial direction. The adjustment ring 3 is provided with a rectangular opening 32 in the axial direction, and each of the two lateral edges of the opening 32 forms a pushing portion 33. The two end portions 21 of each constricting spring 2 are located between the two pushing portions 33 (see FIG. 6) such that when the adjustment ring 3 is rotated (e.g., rotated forward or backward), one of the pushing portions 33 is subjected to the external force and transfers the external force to, and thereby pushes, the corresponding end portion 21 of each constricting spring 2 to loosen each constricting spring 2 elastically; as a result, the constricting springs 2 are no longer tightly wound around the outer periphery of the fixed sleeve 1. The adjustment ring 3 is further provided with a turning portion 34 at one end.

The sleeve base 4 is provided with a third axial hole 41 in the axial direction so that the sleeve base 4 can be mounted around the outer periphery of the adjustment ring 3 in the axial direction. The wall of the third axial hole 41 is protrudingly provided with a push block 42 in the axial direction, and the push block 42 extends into the opening 32 of the adjustment ring 3 and is located between the two end portions 21 of each constricting spring 2 (see FIG. 6). When one of the pushing portions 33 pushes the corresponding end portion 21 of each constricting spring 2, the pushed end portions 21 push the push block 42 and thereby drive the sleeve base 4 into rotation (e.g., forward or backward rotation). An elastic element 43 is provided between the sleeve base 4 and the turning portion 34 of the adjustment ring 3, and a protective cover 44 is mounted around the outer periphery of the sleeve base 4.

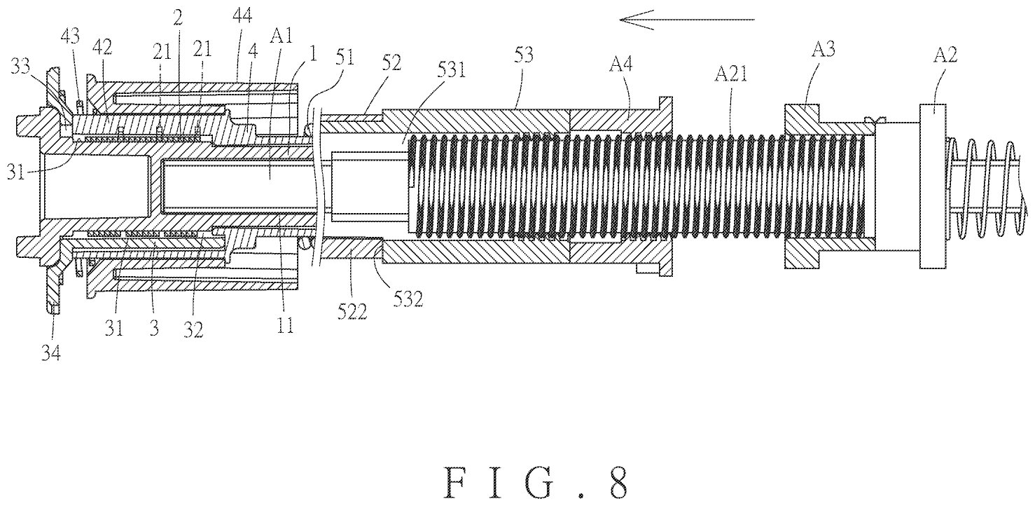

The lower-limit position defining base 5 is threadedly provided on the threaded section A21 of the inner tube A2. The lower-limit position defining base 5 includes a transmission spring 51, a first base body 52, and a second base body 53. The transmission spring 51 is a torsion spring. The transmission spring 51 has a first end 511 coupled to the sleeve base 4 and a second end 512 coupled to the first base body 52. The sleeve base 4 can drive the first base body 52 through the transmission spring 51 and thereby cause rotation (e.g., forward or backward rotation) of the first base body 52. The first base body 52 is provided with a fourth axial hole 521 in the axial direction so that the first base body 52 can be mounted around the outer periphery of the bar A1 in the axial direction. The wall of the fourth axial hole 521 is protrudingly provided at one end with a coupling portion 522 in the axial direction. The second base body 53 is provided with a fifth axial hole 531 in the axial direction, and one end of the fifth axial hole 531 is provided with a coupling groove 532 in the axial direction. The coupling portion 522 is configured to be engaged in the coupling groove 532 so that the first base body 52 can drive the second base body 53 into rotation (e.g., forward or backward rotation). The other end of the fifth axial hole 531 is provided with an internally threaded portion 533 in the axial direction. The internally threaded portion 533 is threadedly connected to the threaded section A21 of the inner tube A2 such that when the second base body 53 is rotated, the threaded section A21 is moved in the axial direction with respect to the internally threaded portion 533 to adjust the position of the lower-limit position defining base 5 in relation to the threaded section A21. When the roller blind fabric A6 (whose bottom portion is mounted with a weighting block) is extended downward, or lowered, and thus drives the outer tube A5 into rotation, the outer tube A5 drives the slidable base A4 to approach the second base body 53 of the lower-limit position defining base 5 in a rotating manner. Once the slidable base A4 contacts the second base body 53, the lowering of the roller blind fabric A6 is stopped (see FIG. 8) at the lower-limit position of the roller blind A.

To use, referring to FIG. 1, FIG. 2, and FIG. 3, the buffering device is mounted to the roller blind A, and then the roller blind A is fixedly mounted on the wall above the window that the roller blind A is intended to expose or cover by being raised or lowered. To raise the roller blind A, the outer tube A5 is driven, either automatically or manually, to pull the roller blind fabric A6 upward and thereby wind the roller blind fabric A6 around the outer tube A5. During the process, the outer tube A5 drives the slidable base A4 toward the upper-limit position defining base A3 along the axial direction in a rotating manner. Once the slidable base A4 contacts the upper-limit position defining base A3 in the axial direction and is thus kept from moving in a rotating manner (see FIG. 7), the raising of the roller blind fabric A6 comes to a halt, and the bottom edge of the roller blind A is consequently stopped at its upper-limit position. To lower the roller blind A, the roller blind fabric A6 is driven, either automatically or manually, to extend downward with the assistance of the weighting block and thus rotate the outer tube A5. The outer tube A5, in turn, drives the slidable base A4 toward the lower-limit position defining base 5 along the axial direction in a rotating manner. Once the slidable base A4 contacts the second base body 53 of the lower-limit position defining base 5 and is thus kept from moving in a rotating manner (see FIG. 8), the lowering of the roller blind fabric A6 comes to a halt, and the bottom edge of the roller blind A is consequently stopped at its lower-limit position.

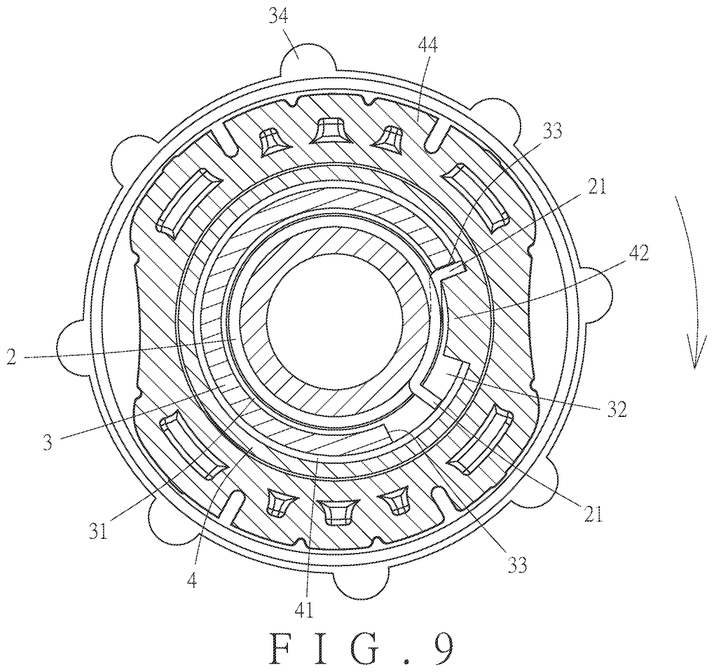

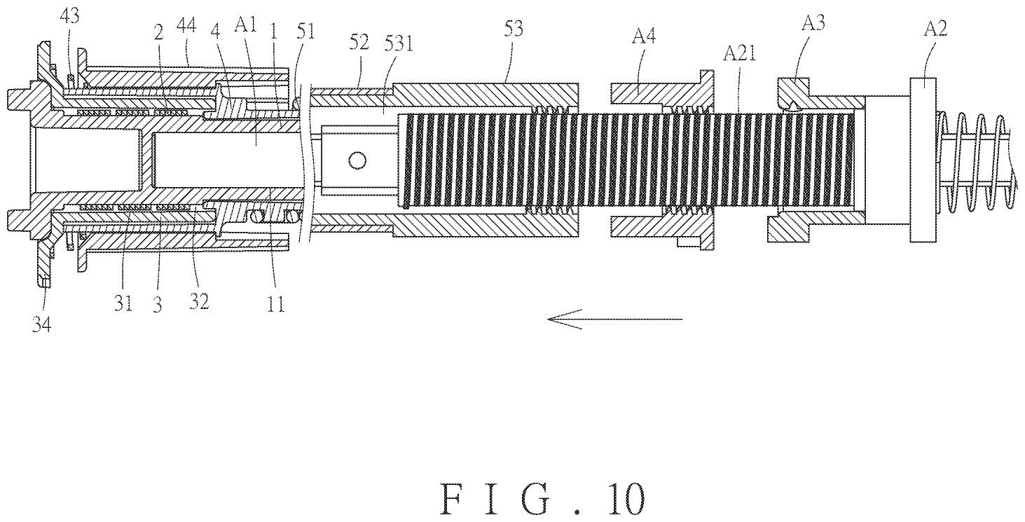

To adjust the lower-limit position of the roller blind A, i.e., the limit of downward extension of the roller blind A, referring to FIG. 1, FIG. 2, and FIG. 4, it is necessary to change the relative positions of the lower-limit position defining base 5 and the threaded section A21 of the inner tube A2, and the first step of doing so is to turn the turning portion 34 of the adjustment ring 3. The direction in which the turning portion 34 should be turned (e.g., in a forward or backward rotation direction) depends essentially on the direction in which the threads of the internally threaded portion 533 and of the threaded section A21 are connected. Once the turning direction is determined, the distance between the lower-limit position defining base 5 and the upper-limit position defining base A3 along the threaded section A21 can be controlled by turning the turning portion 34 in the forward or backward rotation direction. When the turning of the turning portion 34 causes forward or backward rotation of the adjustment ring 3, the pushing portion 33 at the corresponding one of the two lateral edges of the opening 32 of the adjustment ring 3 is subjected to the aforesaid external force, transfers the external force to the corresponding end portions 21 of the constricting springs 2, and thereby pushes those end portions 21 toward the opposite end portions 21 (see FIG. 9) such that the constricting springs 2 are elastically loosened and no longer tightly wound around the outer periphery of the fixed sleeve 1. The loosened constricting springs 2 can be rotated around the outer periphery of the fixed sleeve 1. When the constricting springs 2 are rotated, the end portions 21 pushed by the external force push the push block 42 and thereby rotate the sleeve base 4. When the sleeve base 4 is rotated, the first base body 52 is driven to rotate via the first end 511 and the second end 512 of the transmission spring 51. Once the first base body 52 is rotated, the second base body 53 is driven into rotation due to the engagement between the coupling portion 522 and the coupling groove 532. When the second base body 53 is rotated, the threaded connection between the internally threaded portion 533 of the fifth axial hole 531 and the threaded section A21 of the inner tube A2 allows the threaded section A21 to move in the axial direction with respect to the internally threaded portion 533 (see FIG. 10) such that the position of the lower-limit position defining base 5 on the threaded section A21 is changed. When the distance between the lower-limit position defining base 5 and the upper-limit position defining base A3 along the threaded section A21 is increased or decreased, the distance for which the slidable base A4 has to move in the axial direction in order to contact the second base body 53 of the lower-limit position defining base 5 is also changed. Thus, by adjusting the time it takes for the slidable base A4 to contact the second base body 53 and thereby stop the downward extension of the roller blind fabric A6, the limit of downward extension of the roller blind A, i.e., the lower-limit position of the roller blind A, can be adjusted.

The buffering device in this embodiment of the present invention is so structured that the lower-limit position of the roller blind A can be adjusted immediately without having to detach the entire set of roller blind A from the wall above the window or remove any component of the roller blind A. That is to say, adjustment can be easily made during the installation process of the roller blind A, and this saves a lot of time and effort. The buffering device, therefore, is particularly suitable for use where a large number of roller blinds have to be installed and adjusted.

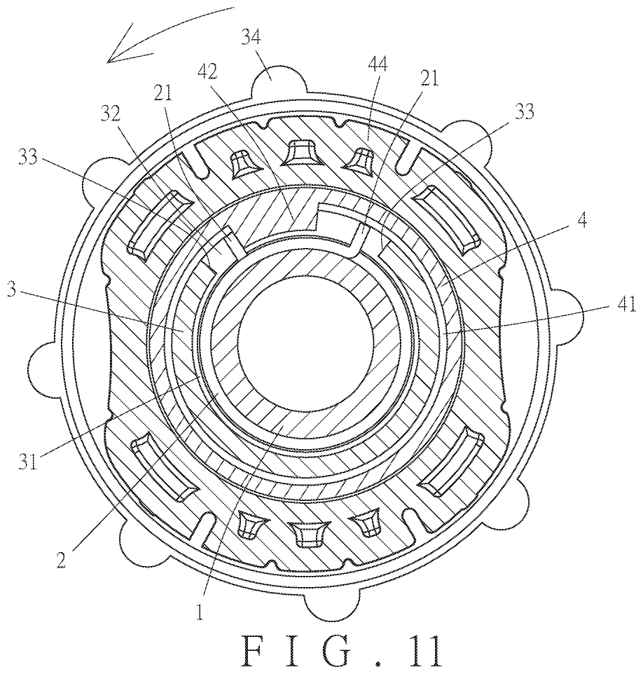

Referring to FIG. 1 and FIG. 8, when the lowering of the roller blind A causes contact between the slidable base A4 and the second base body 53 of the lower-limit position defining base 5, the rotational inertia that has been generated by rotation of the slidable base A4 is transmitted to the second base body 53 such that the second base body 53 is rotated and sequentially drives the first base body 52, the transmission spring 51, and the sleeve base 4 into rotation. When the sleeve base 4 is rotated, the push block 42 pushes the corresponding end portions 21 of the constricting springs 2 in a rotating manner such that each of these end portions 21 is moved away from the corresponding one of the opposite end portions 21 (see FIG. 11). The constricting springs 2, therefore, are wound even more tightly around the outer periphery of the fixed sleeve 1 to stop the sleeve base 4 from rotating, thereby counteracting the rotational inertia transmitted from the slidable base A4. In consequence, the constriction of the constricting springs 2 produces a braking effect that prevents the roller blind A from being lowered excessively.

The above description of an embodiment of the present invention should be able to shed sufficient light on the operation, use, and intended effects of the invention. The disclosed embodiment, however, is only a preferred one of the invention and is not intended to be restrictive of the scope of the invention. Any simple equivalent change or modification based on the appended claims and the contents of this specification should be viewed as falling within the scope of the invention.

What is claimed is:

1. A buffering device capable of lower-limit position adjustment, mounted to a roller blind, the buffering device comprising:
a fixed sleeve mounted around a bar of the roller blind, wherein the bar extends in an axial direction, and the fixed sleeve is not rotatable with respect to the bar;
at least one constricting spring tightly wound around an outer periphery of the fixed sleeve in the axial direction, wherein the constricting spring has two end portions, and when an external force is applied to push the two end portions toward each other, the constricting spring is elastically loosened and no longer tightly wound around the outer periphery of the fixed sleeve;
an adjustment ring mounted around an outer periphery of the constricting spring, wherein the adjustment ring is provided with an opening, the opening has two lateral edges each forming a pushing portion, and the two end portions of the constricting spring are located between the two pushing portions such that when the adjustment ring is rotated, one of the pushing portions is subjected to the external force and transfers the external force to, and thereby pushes, a corresponding one of the end portions of the constricting spring;
a sleeve base mounted around an outer periphery of the adjustment ring, wherein the sleeve base is protrudingly provided with a push block, and the push block extends into the opening of the adjustment ring and is located between the two end portions of the constricting spring such that when any one of the end portions is pushed by the corresponding one of the pushing portions, the push block is pushed by the one of the end portions and rotates the sleeve base; and
a lower-limit position defining base threadedly provided on an inner tube of the roller blind, wherein the lower-limit position defining base is rotatable by the sleeve base via a transmission spring in order to move the inner tube in the axial direction with respect to the lower-limit position defining base.

2. The buffering device capable of lower-limit position adjustment as claimed in claim 1, wherein the bar has a non-circular cross section, the fixed sleeve has an end provided with a first axial hole in the axial direction, the first axial hole has a same cross-sectional shape as the bar, and the first axial hole has a wall located around the bar in a movable manner.

3. The buffering device capable of lower-limit position adjustment as claimed in claim 1, wherein the adjustment ring is provided with a second axial hole in the axial direction, and the second axial hole has a wall located around the outer periphery of the constricting spring along the axial direction.

4. The buffering device capable of lower-limit position adjustment as claimed in claim 1, wherein the adjustment ring has an end provided with a turning portion.

5. The buffering device capable of lower-limit position adjustment as claimed in claim 4, wherein an elastic element is provided between the sleeve base and the turning portion.

6. The buffering device capable of lower-limit position adjustment as claimed in claim 1, wherein the sleeve base is provided with a third axial hole in the axial direction, and the third axial hole has a wall located around the outer periphery of the adjustment ring along the axial direction.

7. The buffering device capable of lower-limit position adjustment as claimed in claim 6, wherein the wall of the third axial hole is protrudingly provided with the push block in the axial direction.

8. The buffering device capable of lower-limit position adjustment as claimed in claim 1, wherein a protective cover is mounted around an outer periphery of the sleeve base.

9. The buffering device capable of lower-limit position adjustment as claimed in claim 1, wherein the lower-limit position defining base is threadedly provided on a threaded section of the inner tube, the lower-limit position defining base comprises a first base body and a second base body coupled to the first base body, the transmission spring has a first end coupled to the sleeve base and a second end coupled to the first base body, and the sleeve base rotates the first base body via the transmission spring.

10. The buffering device capable of lower-limit position adjustment as claimed in claim 9, wherein the first base body is provided with a fourth axial hole in the axial direction, the fourth axial hole has a wall located around an outer periphery of the bar along the axial direction, the wall of the fourth axial hole is protrudingly provided at an end with a coupling portion in the axial direction, the second base body is provided with a fifth axial hole in the axial direction, the fifth axial hole has an end provided with a coupling groove in the axial direction, the coupling portion is engaged in the coupling groove such that the first base body is able to rotate the second base body, the fifth axial hole has an opposite end provided with an internally threaded portion in the axial direction, and the internally threaded portion is threadedly connected to the threaded section of the inner tube such that when the second base body is rotated, the threaded section is moved in the axial direction with respect to the internally threaded portion.
